(19) United States
(12) Patent Application Publication
(10) Pub. No.: US 2004/0154578 A1
(43) Pub. Date: Aug. 12, 2004

(54) Engine connecting rod for high performance applications and method of manufacture

(76) Inventor: Robert R. Weaver, Mooresville, NC (US)

Correspondence Address: ROBERT R. WEAVER, 109 COURTNEY LANE, MOORESVILLE, NC, 28117, US

(21) Appl. No.: 10/079,150

(22) Filed: Feb. 20, 2002

(51) Int. Cl. F02B 75/32

(52) U.S. Cl. 123/197.3; 74/579 E

(57) ABSTRACT

An internal combustion engine connecting rod, having an embodiment defining a hollow beam member and a process of manufacture are disclosed. The improvement substantially reduces beam tensile and compressive stress levels through application of elliptical and oval beam sections, conserving reciprocating and rotating connecting rod weight required in high performance applications.

### BACKGROUND OF THE INVENTION

1. Field of the Invention

This invention relates generally to the field of internal combustion engines having connecting rods of hollow beam construction, more particularly to a method to produce hollow connecting rod having refined elliptical beam cross-sections.

2. Description of Background Information

Users and designers of high performance engines have a history of competitively improving horsepower and operating engines at increased RPM (Revolutions Per Minute). High performance engines generally are within a range of 450 horsepower at 7000 RPM to 820 horsepower at 9200 RPM as relate to the invention and disclosed by this specification. Performance increases and particularly higher RPM impose an exponential increase in stress levels on connecting rods. Designers and manufactures have responded with designs that are light and strong. In so doing connecting rods may have a use life of a few hours in racing. Engine reciprocating components, the piston assembly and that reciprocating portion of connecting rods have mass that translates into high inertia forces. With each engine revolution these inertia forces impose high tensile stress levels that are distributed throughout the connecting rod structure and increase exponentially with higher RPM. By example, tensile force may be approximately 4,200 lbs. at 7,000 RPM and 8,200 lbs. at 9,200 RPM. Also occurring within each engine revolution are compressive forces of combustion exerting a compressive force to the connecting rod. By example, compressive forces may be approximately 9,500 lbs. at 7,000 RPM and 10,600 lbs. at 9,200 RPM. Therefore, with each engine cycle very high tensile and compressive forces are reacting and cycling within a connecting rod and must be considered. It will be appreciated by those skilled in the art of connecting rod design the importance and need for advancements in technology demanded by constantly evolving high performance competition.

The known art in high performance connecting rods has generally evolved into the beam member having an H-shaped (H-Beam) cross-section that is dominant. Although, the traditional I-beam shape cross-section is also capable of offering competitive performance. Engineering art effectively demonstrates that a hollow beam structure provides improved column strength for a given mass compared to other cross-section choices. There are several versions of hollow beam structured connecting rods known. Generally they are castings with round tube beams, and there are attempts at making hollow connecting rods by joining separate halves into a one-piece connecting rod. Examples of the known art require numerous manufacturing steps and are generally casting or wrought metals, not high strength materials required for performance engines. The examples do not exhibit weight conservation capabilities or stress level reduction as efficiently as this invention. Hollow connecting rods made with known art have not proved successful in high performance engines as demanded by this specification, and are not in known use with previous technology.

In the field of hollow connecting rod manufacturing, designs and patents have generally centered on casting processes. Cast rods having cylindrical (round) tubular beam members have been disclosed in, for example, U.S. Pat. No. 5,140,869 to Mrdjenovich, et al (1992). Casting materials commonly do not provide sufficient tensile and yield strength values required where high performance is maximized and therefore are not used. High performance connecting rods are commonly manufactured from metal billets or forgings of aircraft quality and certification to withstand high performance use. Another disadvantage of a round cylindrical connecting rod beam is the diametrical dimension being limited by bearing journal member width. A further disadvantage of a round connecting rod beam is the inability to vary section characteristics directionally as required to distribute stress evenly throughout a beam and achieve both low stress levels and section mass.

Other previous art discloses a hollow connecting rod with the beam member having a “trapezoidal silhouette of the tubiform midsection” as noted in U.S. Pat. No. 3,482,467 to Volkel (1969), the beam member cross-section is defined with wide extensive arcuate sides. And, is an investment casting in order to be manufactured. U.S. Pat. No. 5,370,093 to Hayes (1994) requires fabricated “multiple piece assembly”. Features of the general shape for both patents require manufacturing time and process specifics that add effort to machine and produce, unsatisfactory for a simple clean connecting rod demanded for high performance use. Reviewing the work of Volkel and Hayes and others do not relate an obvious indication of art for the conservation of mass and structural stress level distribution technology as is disclosed with this specification.

Users of high performance connecting rods have participated in research to find new concepts to achieve reduced stress levels through even force distribution and maximum reduction of reciprocating and rotating mass by utilizing new concepts not previously identified. The resulting effort has led to this new invention.

### SUMMARY OF THE INVENTION

The primary objective and advantage of this invention is to meet user requirements to invent a new type connecting rod of near maximum achievable lightweight and provide reliable performance at high RPM (Revolutions Per Minute) and have a predictable fatigue life. Particularly, an invention that is manufactured from high strength materials, using established procedures common in high performance connecting rod manufacturing.

A major objective and advantage of the present invention is a new improved beam cross-section of minimal surface area and mass by embodiment of an optimized refined ellipse or a related oval cross-section form. Particularly, an ellipse form beam member embodiment providing uniform load distribution and transition to bearing regions, thereby providing smooth and even distribution of stress force throughout a connecting rod. Thus achieving lower stress levels, less mass and rod weight. Important to the objective of even stress force distribution is the ellipse cross-section form feature. The objective and advantage of the optimized refined hollow ellipse beam form is having variable beam wall section dimensions being placed directionally as required from a center axis to evenly distribute unique stress force transients occurring in connecting rods. A further objective of the invention is provision to increased ellipse beam wall distance from center axis in direction of crankshaft rotation to further even connecting rod stress force distribution.

Another objective and advantage of this invention is to provide a smooth aerodynamic shape to reduce effects of rod contact with the ambient oil particle environment and air occurring within an engine at high RPM.

Another objective and advantage of this invention is to disclose a new connecting rod beam cross-section geometry being closely related to the ellipse form, by using the teachings of this invention to define that cross-section form. The purpose being to make available connecting rods having structural and weight compromises that are acceptable for some high performance uses at reduced manufacturing cost. Particularly, possessing performance superior to conventional connecting rods. This objective being accomplished by varying cross-section shape directional changes, using modified cross-section geometry forms, having a closely related elliptical polyline, parabolic or circular parametric forms. The circular semi-oval form being preferred.

Another objective and advantage of this invention is having a procedural embodiment to locate dimensionally and typically place mathematically similar formatted profile forms to define a connecting rod in a consistent repeatable fashion and being applicable to a variety of connecting rod designs. A further objective of this invention is to reduce the number of elements required to define a connecting rod to a minimal few selective section forms strategically placed by computer design. This objective facilitates connecting rod design by computer, finite analysis and computer controlled machining programming. Wherein a computer design file may be generated and transferred by electronic means to these disciplines. By example, typically locating placement of cross-sections to define a beam member and embodiment of lofting procedures for beam transition to bearing connection regions. In total a “continuity of features” embodiment.

Another objective and advantage of this invention is that the portion of the total hollow connecting rod mass consisting of reciprocating weight (that mass above the connecting rod's center of gravity) is reduced. This improvement objective is to reduce connecting rod tensile stress occurring at high RPM and add to improve crankshaft turning moments, a performance improvement. A further improvement objective of the hollow connecting rod is the reduction of rotating mass (that mass below the connecting rod's center of gravity), wherein crankshaft balancing counter weight reduction is possible.

Another objective and advantage of this invention being application of the embodiments to other than the high performance use addressed herein this specification. Such as disclosure to adapt to casting or manufacturing conventional connecting rods using the teachings of the present invention.

Another objective and advantage of this invention being a new application of invention to provide a reliable oil transfer tube feature from the crankshaft region to the piston pin being applicable to hollow connecting rods.

Another objective and advantage of this invention being a new application of invention to provide a connecting rod bearing cap alignment embodiment to provide a more rigid alignment connection.

Other objectives and advantages of the present invention will become apparent from the following descriptions, taken in connection with the accompanying drawings, wherein, by way of illustration and example, an embodiment of the present invention is disclosed.

### BRIEF DESCRIPTION OF THE DRAWINGS

The drawings constitute a part of this specification and include the embodiment of this invention.

FIG. 1 is a front elevation view of a connecting rod assembly illustrating the connecting rod of the present invention.

FIG. 2 is a side elevation view of the connecting rod of the present invention.

FIG. 3 is a longitudinal section view of the connecting rod of the present invention taken along the line 3-3 of FIG. 2.

FIG. 4 is a transverse sectional view of the connecting rod of the present invention taken along the line 4-4 of FIG. 1.

FIG. 5 is a transverse sectional view of the connecting rod of the present invention taken along the line 5-5 of FIG. 1.

FIG. 6 is a front elevation view of the connecting rod assembly of the present invention for purpose of illustrating transverse sections having ovate plane form.

FIG. 7 is a transverse section view of the connecting rod of the present invention taken along the line 6-6 of FIG. 6.

FIG. 8 is a transverse section view of the connecting rod of the present invention taken along the line 7-7 of FIG. 6.

### DETAILED DESCRIPTION OF THE INVENTION

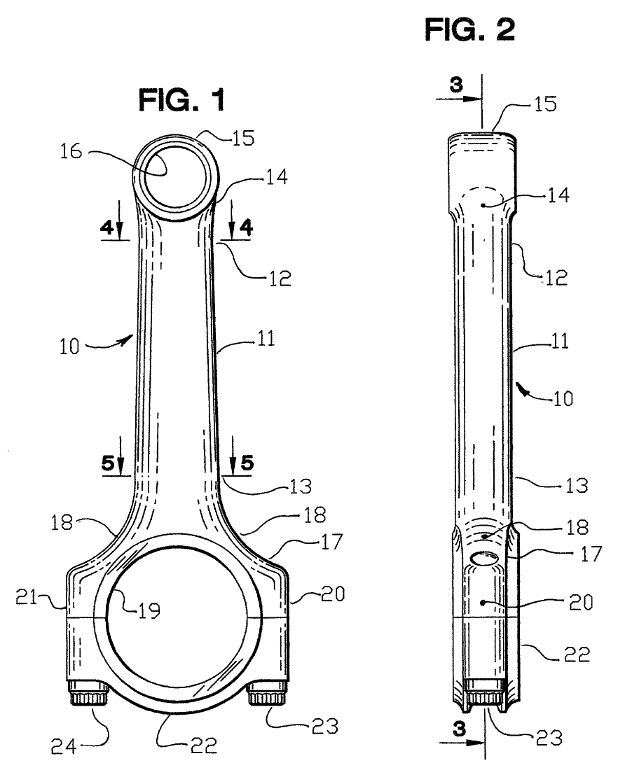

With reference to FIG. 1 and FIG. 2 of the drawings there is depicted a connecting rod 10 for use in high performance engines. The connecting rod 10 comprising an elongate longitudinal beam member 11 having two opposite ends 12, 13 each forming a one-piece connection. Connection to first end 12 being arcuate sides 14, including piston pin connecting member 15 having a round bearing surface 16, for cooperating with a piston pin. At beam member 11 opposite second end 13 is a crankshaft journal connecting member 17, having arcuate sides 18, including a round bearing surface 19 for cooperating with a bearing insert and crankshaft journal when secured thereto (not shown). Connecting member 17 having bolt boss 20, 21, secured thereto cap member 22 and bolts 23, 24.

As noted in FIG. 1 beam cross-sections cut lines 4-4 and 5-5 define the beam structure, a “continuity of features” embodiment, unique to this invention. The continuity being established whereby design specified ellipse form and dimensional placement of only 2 cross-sections positions being required to define the beam member configuration of this example. Further details of continuity features being disclosed continuing within the invention specification description.

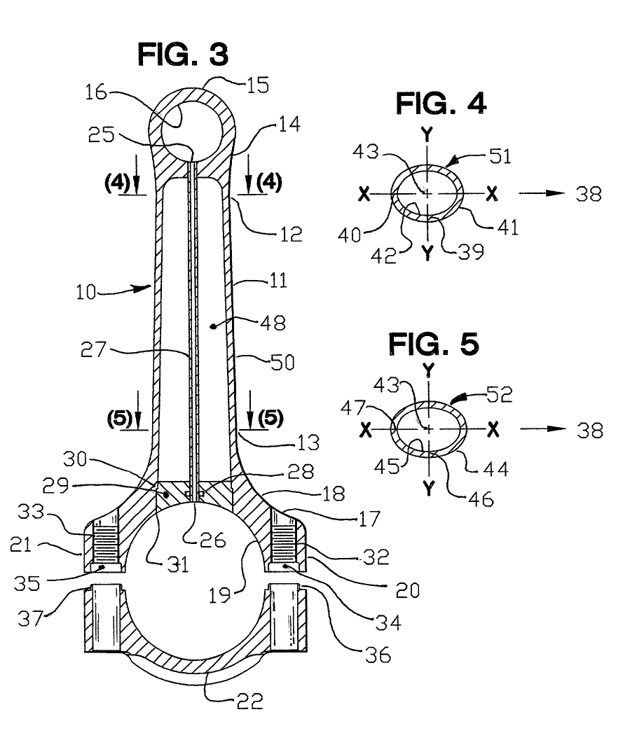

With reference to FIG. 2, a longitudinal section view is taken along cut line 3-3 to disclose the inner structure of the connecting rod of this invention, best shown in FIG. 3 as follows. The piston pin connecting member 15 defines a first passage 25 which extends longitudinal axially with respect to the beam member 11 to the round piston pin bearing surface 16. Viewing the opposite end, within the crank journal connecting member 17 is a second passage 26, extending to the round bearing surface 19. Continuing with FIG. 3 thereto passage 25 and 26 is secured oil passage tube 27 for the purpose of transferring oil from second passage 26 to first passage 25. Oil tube 27 being fixed and secured at first passage 25. Oil tube 27 being sealed at second passage 26 thereby a unique oil-ring 28 packing seal embodiment providing for axial motion differential between tube 27 and the connecting rod body region, thereto eliminate interacting movement and stress.

Continuing in FIG. 3, the elongate beam member 11 there being a hollow cavity 48 with a thin wall 50 of elliptical cross-section. Details of elliptical wall cross sections are disclosed in FIG. 4 and FIG. 5. Now continuing in FIG. 3, the cavity 48 of connecting rod member 11 there being an insert 29 embodiment fitted into receptacle 30 for the purpose of sealing the cavity 48. The insert 29 is bonded or fusion welded 31. With reference to FIG. 1, the bolts 23, 24 extend through bolt boss 20 and 21 from bearing cap 22 into threaded bores. Returning to FIG. 3, threaded bores 32 and 33 are illustrated. The bolts 23,24 have been omitted from FIG. 3 for clarity to disclose the embodiment whereby bearing cap 22 assembles and therein is aligned to crank journal connecting member 17 as follows. Alignment receptacle elements 34, 35 are circular machined into bolt boss 20, 21 concentric with bolt and thread axis having a depth to accept matching, and close fitting extended machined circular elements 36, 37 on the mating surface of the bearing cap 22.

With reference to FIG. 1 to note locations of cut lines 4-4 and 5-5 therein indicating placement of a first and second elliptical cross-section forming the beam member continuity embodiment. The elliptical cross-section locations terminate at radii arcuate transitions 14 from first end 12 and radii arcuate transitions 18 at opposite second end 13. Between the section locations the beam 11 follows a generally linear progression.

Returning to FIG. 4 and FIG. 5, the beam member elliptical cross-section embodiment feature of this invention there being disclosed. As best shown in FIG. 4, the first elliptical cross-section 51. Note axis X-X of first elliptical cross-section 51, axis X-X is in the direction of crankshaft rotation 38 and is the major (long) axis of the elliptical form. Axis Y-Y is in the direction normal to crankshaft rotation and is the minor (short) axis of elliptical form. The ellipse plane being classic geometric ellipse polyline periphery, or modified parabola, or curricular periphery, or combinations thereof. Preferably, the ellipse form therein being most effective to conserve mass and provide optimum strength as illustrated in FIG. 4. Wall thickness at locations 39 and 40, and cross section area are defined by the dimensional difference between axis X-X and axis Y-Y of external ellipse 41 and internal ellipse 42. Structural requirements and finite analysis establish required external and internal ellipse dimensions about the center longitudinal axis 43, thus providing proper cross-sectional area and wall thickness proportions to define ellipse or similar form profile dimensions. Wall thickness at 39 and 40 may differ as required for strength, in this example wall thickness is 2.3 mm continuously around the ellipse form.

Returning briefly to FIG. 1 to view section location at cut line 5-5 therein disclosing placement for the second elliptical cross-section that defines the beam member opposite second end 13. The elongate elliptical beam member 11, terminates whereby the beam transitions to flank 18. Turning again to FIG. 5, details of the second elliptical cross section 52 there being disclosed. Therein minor axis Y-Y length of second ellipse 52 having the same length as the minor axis Y-Y of first ellipse 51 (FIG. 4). Wall thickness 39 therein being constant from first ellipse 51 longitudinally to second ellipse 52, being 2.3 mm for this example. Continuing with FIG. 5, major axis X-X is illustrated longer by 3 mm for second ellipse 52 than for first ellipse 51. Being particularly longer for this example than normal to graphically illustrate the important invention embodiment of beam tapering provided by the ellipse form in direction of crankshaft rotation 38. The second elliptical cross section 52, having both external ellipse 44 and internal ellipse 45, therein illustrating the same wall thickness at locations 46 and 47 thereby indicating a constant longitudinal wall thickness of 2.3 mm throughout beam 11 for this example.

The teaching disclosed by this invention demonstrate the “continuity of features” embodiment wherein as few as two elliptical cross-sections define a connecting rod beam member. The disclosed ellipse embodiment defining dimensions for the major X-X axis and minor Y-Y axis possess a unique capability to vary wall thickness proportions to optimize strength and weight conservation. This particular novelty being especially suited to smooth directional transient force loads and stress levels in structural regions of high performance connecting rods. The example used in this disclosure are for a 450 horsepower engine at 7200 peak RPM currently being used in a major racing series. Connecting rod tensile forces were calculated from the reciprocating assembly mass acceleration and compressive forces from a combination of cylinder compression readings and force calculations. Finite analysis procedures were used to compare an actual conventional H-Beam high performance connecting rod in use to the hollow beam connecting rod disclosed by this invention using the same tensile and compressive loads. The connecting rod of this disclosure demonstrated significantly lower total mass (weight), lower reciprocating mass and significantly lower stress levels in the beam section resulting from even load distribution throughout the beam longitudinal progression, thus smoothing and evening stress distribution. Thereby demonstrating potential improvements possible from this invention by placing cross-sectional mass elliptically distant from the beam center axis. A hollow beam structure with cross-sectional mass distributed in the manor taught here is stronger in column strength and in bending strength and requires less mass. The greater major X-X axis dimension feature being an especially important improvement to bending resistance and significantly improving column strength in connecting rods.

Returning to FIG. 1, this specification now discloses the embodiment of elongate elliptical beam member 11 structural transition to the piston pin connecting member 15 and the crank-shaft journal connecting member 17. Elliptical beam member 11 transforms into flanks 14 of piston pin connecting member 15 and into flanks 18 of crankshaft connecting member 17. Both transitions therein accomplished by the “continuity of features” embodiment process. Continuing in FIG. 1, the elliptical vertices at cut lines 4-4 for ellipse 51 (FIG. 4) radially sweep or loft into forming flanks 14 into piston pin member 15. Similarly the elliptical vertices at cut line 5-5 for ellipse 52 (FIG. 5) thereby radially sweep or loft into forming flanks 18, thereto merge using “radial guide curves” to define the surface of flank 18. Flanks 18 continue radially merging thereto a third lofting elliptical form cross-section (not shown), positioned perpendicular to surface of flank 18 and centered on bolt bosses 20,21. The sweep and lofting profile features all having generally an ellipse form, a “continuity of features” mathematical relation to the beam member 11 and ellipse 52, that facilitating lofting of flanks.

The embodiment of “continuity of features” has now demonstrated how the elongate elliptical beam member 11 is formed by 2 elliptical cross-section features and flanks 14 and 18 being formed having specific dimensional radial sweep to bearing areas or loft to specific ellipse profile feature positions. The embodiment disclosing “continuity of features” greatly simplifies design and manufacturing by reducing connecting rod design to a series of cross-sections having mathematical identity.

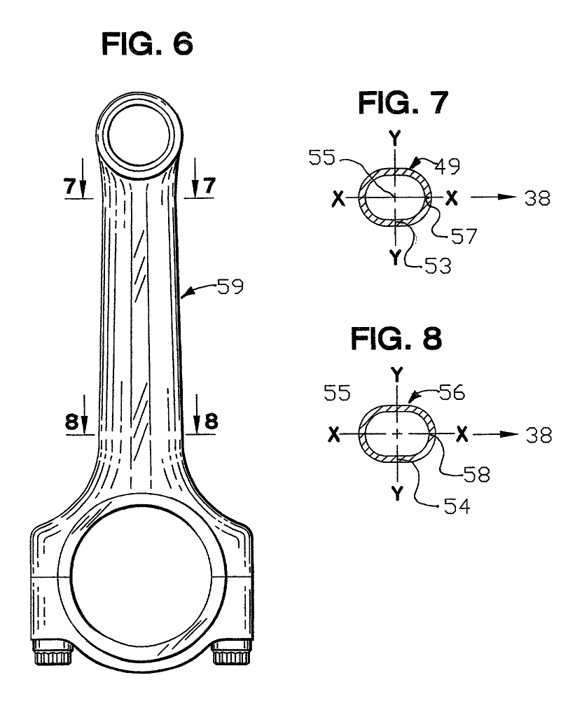

There is a need for a near high performance connecting rod that provides cost economies in some performance applications, and being designed with an acceptable weight to strength penalty, and having improved strength over H-beam connecting rods. Turning to FIG. 6 of the drawings there is disclosed a connecting rod having the same dimensional configuration as depicted in FIG. 1 cross-sections cut lines 7-7 and 8-8 are taken at same locations and have the same axis X-X and axis Y-Y dimensions. This disclosure defines a preferred embodiment using the teachings of this specification applied to a connecting rod having lower manufacturing cost as a priority. Turning to FIG. 6 therein being the longitudinal beam 59 employing a cross-section variation of the present invention. As best seen in FIG. 7 and FIG. 8, cross-sections 49 and 56 are disclosed, As noted the axis X-X and axis Y-Y dimensions and wall thickness remain as described in FIG. 1 through FIG. 6. Now continuing in FIG. 7 and FIG. 8, cross-sections 49 and 56 are formed in this illustration therein being preferred semicircular at vertices and centered on axis 55. FIG. 7 wall thickness 57,53 in this example being 2.3 mm. And, FIG. 8 wall thickness 58,54 in this example being 2.3 mm. Other aspects such as beam member features, bearing end connection member and related “continuity of features” are applicable to this embodiment being consistent with this specification teaching.

Returning to FIG. 3. The connecting rod illustrated for this invention has a configuration having advantages of being manufactured by other methods, particularly investment casting or conventional casting procedures suitable for non-high performance applications. As best seen in FIG. 4 and FIG. 5 of this disclosure thereby illustrating that the connecting rod of this invention provides ideal casting form, having generous casting draft in the Y-Y direction and casting parting lines through the preferred X-X axis. The hollow cavity 48 is tapered, facilitating use of pattern removal and for placement of casting cores. Cavity insert 29 therein installed in accordance with previous disclosure in FIG. 3. The connecting rod configuration herein being a smooth clean shape particularly suited for casting processes. Further, the unique ellipse beam form of this invention improves cast connecting rod strength and provides smoother stress distribution over known art.

Reference Numerals in Drawings

| | |
|---|---|
| 10. | connecting rod |
| 11. | beam member |
| 12. | first end |
| 13. | second end |
| 14. | arcuate sides (piston pin member) |
| 15. | piston pin member |
| 16. | bearing surface |
| 17. | crankshaft connecting member |
| 18. | arcuate sides (crankshaft member) |
| 19. | bearing surface |
| 20. | bolt boss |
| 21. | bolt boss |
| 22. | cap member |
| 23. | bolt |
| 24. | bolt |
| 25. | first passage |
| 26. | second passage |
| 27. | oil tube |
| 28. | o-ring packing |
| 29. | insert |
| 30. | receptacle |
| 31. | bonding |
| 32. | threaded bore |
| 33. | threaded bore |
| 34. | alignment receptacle |
| 35. | alignment receptacle |
| 36. | circular element |
| 37. | circular element |
| 38. | direction of rotation |
| 39. | wall thickness Y--Y FIG. 4 |
| 40. | wall thickness X--X FIG. 4 |
| 41. | first external ellipse FIG. 4 |
| 42. | first internal ellipse FIG. 4 |
| 43. | center axis FIG. 4, 5 |
| 44. | second external ellipse FIG. 5 |
| 45. | second internal ellipse FIG. 5 |
| 46. | wall thickness Y--Y FIG. 5 |
| 47. | wall thickness X--X FIG. 5 |
| 48. | cavity |
| 49. | first ellipse FIG. 7 |
| 50. | thin wall |
| 51. | first ellipse FIG. 4 |
| 52. | second ellipse FIG. 5 |
| 53. | wall thickness Y--Y FIG. 7 |
| 54. | wall thickness Y--Y FIG. 8 |
| 55. | center axis FIG. 7, 8 |
| 56. | second ellipse FIG. 8 |
| 57. | wall thickness X--X FIG. 7 |
| 58. | wall thickness X--X FIG. 8 |

What I claimed is:

1. An engine connecting rod having hollow beam elliptical form being connected to a piston pin bearing boss member and a crankshaft bearing boss member joined thereto by arcuate surface flanks to bolt bosses located each side of the crankshaft bearing boss there to connect with a connecting rod bearing cap member, comprising:
a beam member being hollow, having elliptical outer surface form cross-sections dispersed longitudinally and centered on the connecting rod axis, ellipse major (long) axis being in direction of crankshaft rotation and ellipse minor (short) axis being normal to crankshaft rotation, therein having positioned at least two elliptical profile planes to define said hollow beam member, consisting of a first or upper elliptical cross-section plane profile for joining into said piston pin bearing boss, therein being a second or lower elliptical cross-section plane profile for joining into said crankshaft bearing boss, beam member outer surface form thus being defined by linear progression between the two elliptical cross-sectional plane profiles, wall thickness and internal cavity surface therein being defined in the same procedural manor, being an internal elliptical cross-section form on the same plane as each outer surface ellipse and progressing linearly between each of the two dispersed internal elliptical cross-section profiles, thus defining the beam member internal surface, said wall thickness proportions and elliptical dimensions for both external ellipse and internal cavity ellipse axis dimensions and ellipse profile form are determined by stress level design requirements using known engineering art, the hollow beam member being thus developed using two elliptical plane profiles placed dimensionally following “a continuity of features” process, said ellipse cross-section profile form therein defined being a plane curve having true classic ellipse form or ellipse plane curve being a polyline, or other closely related forms of this family, being parabolic or circular parameter form or combinations;
a cylindrical piston pin bearing boss member to accept the piston pin and piston assembly, said piston pin boss member having a specified dimensional cylindrical form with a bearing bore, wherein said piston boss outer end diametrical surfaces are formed with elliptic corner shape, said piston pin boss forms a one piece arcuate flank connection thereto the elliptical beam member upper ellipse cross-section plane profile placement, said arcuate flank element being formed wherein each ellipse vertices of the beam member upper ellipse major axis sweeps having a radial dimension into the piston pin boss region, a crankshaft bearing boss member connection forming one piece arcuate flank surface connections from the elliptical beam member lower or second ellipse cross-section plane profile placement, said arcuate flank surface element being formed whereby each ellipse vertices on the beam member second ellipse major axis end sweeps radially into the crankshaft boss region, thereto a radial “guide curve” path of specified radii, continuing and merging by computer lofting procedure into a third ellipse having semi elliptical form being positionally located symmetrically to each bolt boss center axis region, therein using a continuity of ellipse forms thereto lofting flank surfaces from beam member second ellipse to a third ellipse having a form cooperating with bolt boss configuration;
a connecting rod bearing cap member being half circular aligned and cylindrical to the upper connecting rod crankshaft journal bearing member, said bearing cap being with alignment sleeves machined onto the bearing cap surface and secured with bolt connections, said alignment sleeves being raised machined circular elements on the mating surface of the bearing cap closely fitting into matching receiving alignment receptacles machined into the upper half of the connecting rod body, alignment sleeves and through bolts being located on the same axis.

2. The connecting rod of claim 1, wherein said hollow beam member cavity opening at crankshaft connection is closed within having one or more inserts, said insert or inserts being adaptable to locating an oil transfer tube as noted in claim 3, insert being fitted to a receptacle provided at the opening, insert being bonded or fusion welded in place to the beam cavity opening, insert being coincident with the surface of the crankpin bearing bore.

3. The connecting rod of claim 1, wherein a hollow connecting rod beam member therein being fitted with a tube member positioned on said connecting rod axis for the purpose of transferring oil from the crankshaft to the piston pin bearing surface, said tube member being fitted and secured to a receiving receptacle at the piston pin boss, at the crankshaft bearing end the cavity sealing insert being fitted with an o-ring packing to accept and seal the opposite end of the tube member at the crankshaft bearing end, thereby providing for axial motion differential between members.

4. The connecting rod of claim 1, wherein the beam member having a first (upper) external and internal elliptical cross-cross section, wherein the ellipse defining major axis, being centered longitudinally progresses to the second (lower) beam external ellipse, there the second ellipse major axis's being made longer proportionally to affect a gradual increase in beam taper extending from the piston pin boss longitudinally toward the crankshaft bearing region, and defining a linear increase in wall thickness along the longitudinal sides in the direction of rotation, thereby having taper of greater width and wall thickness at the crankpin boss region for improved stress flux control.

5. The connecting rod of claim 1, wherein said hollow beam member having related cross-section profiles developed following the disclosed teachings claimed by the present invention being other than classic ellipse, therein being elliptical polyline, parabolic or particularly having circular parameter related profile being a cross-sectional shape defined having side walls longitudinally equidistant and to the center axis, wherein said side wall ends are joined to enclose with a semicircular wall having vertices at the major (long) axis ends, said cross-section major axis dimensional length varies in a linear perspective with the distance from the piston pin bearing boss connection to the crankshaft bearing member connection, thus defining an embodiment of a linear tapered side beam member in the plane of rotation particular to this invention, said major axis length of external cross-section and internal cavity cross-section proportionally increase approaching crankshaft bearing member, thus gradually defining a lineal increase in wall thickness at the vertices of the major axis in direction of rotation, strength and required dimensions being determined from engineering analysis for a particular application.

6. Claim is made for the embodiments and claims disclosed for this invention and particular to the teachings of this present invention being manufactured by other manufacturing methods, particularly being adapted by investment casting or conventional pattern or die forming casting art forms.
